(19) United States
(12) Patent Application Publication
(10) Pub. No.: US 2011/0070789 A1
(43) Pub. Date: Mar. 24, 2011

(54) Insulative barrier blanket with enhanced performance

(75) Inventors: Robert Michael Kalb, SR., Oneida, IL (US); Robert Michael Kalb, JR., Wataga, IL (US)

(73) Assignee: Kalb Corporation, Oneida, IL (US)

(21) Appl. No.: 12/586,508

(22) Filed: Sep. 23, 2009

(51) Int. Cl. B32B 5/02; B32B 27/34; B32B 15/04; B32B 3/06; B23P 11/02

(52) U.S. Cl. 442/1; 428/474.4; 428/457; 428/102; 29/446

(57) ABSTRACT

This invention pertains generally to means for controlling transfer of thermal energy and specifically to a laminate material comprising functional layers, wherein the functional layers are combined into an insulative barrier blanket that is circumscribed about a high temperature structure or source. The insulative barrier blanket is comprised of a high temperature abrasive and puncture resistant outer shell, a thermal insulation core, and an interior protective layer. The outer shell is preferentially made of a hydrophobic and/or oleophobic fabric layer, which is resistant to abrasion, impact, sound conduction and/or puncture. The insulative barrier blanket is optionally retained about said high temperature structure or source through use of retentive closures having enhanced means for manipulation by hand and reduces the potential creation of foreign object debris.

### BACKGROUND OF THE INVENTION

In modern industry, high environmental temperatures are often generated as part of a purpose driven process or as a by-product from operating equipment. High temperatures are routinely produced by equipment designed to generate motive force or electrical power such as by the operation of an internal combustion engine as a power source for a vehicle or generator. Similarly, high environmental temperatures are produced when conducting elevated temperature fluids from a generation point to an exit or utilization point, such as exemplified by steam production in a facilities plant and transfer pipelines in factory installations. The generation of high environmental temperatures within associated spaces poses a significant issue in terms of equipment performance, maintenance, and operational lifespan, as well as personal comfort of operators and damage caused by deleterious thermal conduction into other associated equipment and undesirable noise released by the equipment.

To combat the generation of high environmental temperatures, the common practice has been to use structures positioned between the high temperature source and the environment described about the high temperature source. Various structures having thermal insulative properties have been proposed and used in the industry for a number of years, with a number of different technologies represented dependent upon the specific needs or requirements. In general, the thermal insulation properties include non-conductive media, in close proximity to the high temperature source.

The prior art present a number of alternative means for maintaining thermal isolation. U.S. Pat. No. 5,811,168 to Rasky, et al. utilizes a foil layer as a means for further constraining possible thermal conduction possible by air conduction through the insulative blanket construction. U.S. Pat. No. 5,139,839 to Lim teaches to an insulative blanket having a defined seam form to aid in preventing thermal conduction through a metal mesh wrapped construct. Great Britain Patent No. 1,268,626 to Coombs, et al. employs quilted PTFE facing and a metal foil reverse facing wherein between the two facings is loaded silicon dioxide spheroid filler. Japanese Patent No. 3,041,296 to Miyake, et al. approaches thermal management for a vehicle engine bay utilizing a glass fiber outer structure surrounding a batting of ceramic fibers.

Prior art attempts to address have met with limited success, with issues encountered in insulation blanket effective life-span, durability and means for securing said insulation blankets to the high temperature sources. The inventors of the present invention have sought to address these issues in a prior U.S. patent application Ser. No. 09/628,733, now issued as U.S. Pat. No. 6,444,287 and hereby incorporated by reference in its entirety. Important aspects presented previously by the inventors include a high temperature insulation blanket for an exhaust system of an internal combustion engine. The user can selectively manufacture the blanket to encompass any engine parts deemed desirable. All sides of the insulative blanket have a high temperature abrasive resistant outer shell material fixedly attached thereto. The high temperature insulative blanket is comprised of a ceramic core having an interior engine engaging layer and an exterior atmospheric air layer. The interior layer is comprised of a nickel alloy, such as INCONEL or MONEL (both of which are registered trademarks of Huntington Alloys) in the form of foils and mesh material that provides spacing and fluid barrier between the engine components and the ceramic fill. The exterior layer in the previous disclosure comprised a PTFE (i.e. “TEFLON” a registered trademark to DuPont de Nemours) layer that is substantially impervious to petroleum based products and solvents. The previous application also presented a novel means for releasably affixing an insulative blanket about a high temperature structure through the use of plural spring elements drawn across opposing edges of the circumscribed insulative blanket and engaged upon an equivalent number of “L-shaped” hooks.

Since the filing of their previous application, the inventors have continued to develop insulative barrier blanket technology in response to new design requirements and as such, have created an enhanced performance insulative barrier blanket. The insulative barrier concept of the present invention is directed to a laminate construct having better conformability, high noise isolation, greater durability and an easier means of releasably securing said insulative barrier blanket about a high temperature source.

### BRIEF SUMMARY OF THE INVENTION

This invention pertains generally to means for controlling transfer of thermal energy and specifically to a laminate comprising functional layers, wherein the functional layers are combined into an insulative barrier blanket that is circumscribed about a high temperature structure or source. The insulative barrier blanket is comprised of a high temperature abrasive and puncture resistant outer shell, a thermal insulation core, and an interior protective layer. The outer shell is preferentially made of a hydrophobic and/or oleophobic fabric layer, which is resistant to abrasion, impact, and/or puncture. Advantageously, said interior protective layer includes a high temperature resistant mesh and a high temperature resistant liner, which in combination provide an initial air void between said high temperature structure or source and said thermal insulation core, thereby improving the thermal transfer resistance of the insulative blanket. Said thermal insulation core is comprised of a suitable material resistant to thermal conduction such as attained by use of inorganic substrates.

In an embodiment of the present invention, the outer shell of the insulative barrier blanket laminate is a fabric formed from an impact and abrasion resistant organic composition.

An additional embodiment of the present invention, the outer shell of the insulative barrier blanket laminate is a fabric formed from an impact and abrasion resistant polyamide composition.

A further embodiment includes an insulative barrier blanket wherein the thermal insulation core comprises a secondary thermal liner proximal to said interior protective layer and an isolation fill layer. The isolation fill layer may optionally includes an inorganic low density, solid state bead, particle, fragment, or predefined simple or compound geometric shape, shapes or combinations thereof.

A further embodiment of the present invention includes enhanced noise isolation by combination of specified layer constructs with enhanced means for retention of the insulative barrier. In such constructs one or more of the component layers described may be combined into a single layer.

Further, the insulative barrier blanket is optionally retained about said high temperature structure or source through use of retentive closures having enhanced means for manipulation by hand and reduces the potential creation of foreign object debris.

Other features and advantages of the present invention will become readily apparent from the following detailed description, the accompanying drawings, and the appended claims.

### BRIEF DESCRIPTION OF THE SEVERAL VIEWS OF THE DRAWING(S)

The invention will be more easily understood by a detailed explanation of the invention including drawings. Accordingly, drawings, which are particularly suited for explaining the inventions, are attached herewith; however, it should be understood that such drawings are for descriptive purposes only and as thus are not necessarily to scale beyond the measurements provided. The drawings are briefly described as follows:

FIG. 1 is a perspective view of an insulative barrier blanket releasably attached to a high temperature source in accordance with the present invention.

FIG. 2 is a perspective view of an insulative barrier blanket in a closed or “engaged” orientation.

FIG. 3 is a perspective view of an insulative barrier blanket in an open or “unengaged” orientation.

FIG. 4 is a cross-sectional view of the present insulative barrier blanket.

FIG. 5 is a side view of an insulative barrier blanket depicting a representative enhanced spring closure means.

FIG. 6 is a side view of a representative enhanced spring closure with integral secondary grasp loop.

FIG. 7 is an end view of a representative enhanced spring closure with integral secondary grasp loop.

FIG. 8 is a side view of a representative enhanced spring closure with integral secondary grasp loop being engaged upon a corresponding “L-shaped” hook on an opposite edge of an insulative barrier blanket.

### LIST OF REFERENCE NUMERALS

With regard to reference numerals used, the following numbering is used throughout the drawings: 10 insulative barrier blanket 12 exhaust stack 14 vehicle 16 seam protection 18 high-temperature resistant thread 20 mesh 22 thermal insulation core 24 outer protective shell 26 closure springs 28 inside seams 30 outside seams 32 liner 34 secondary grasp loop 42 L-shaped hook 44 loop 46 spring loop 48 stud 50 rivet face.

### DETAILED DESCRIPTION OF THE INVENTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

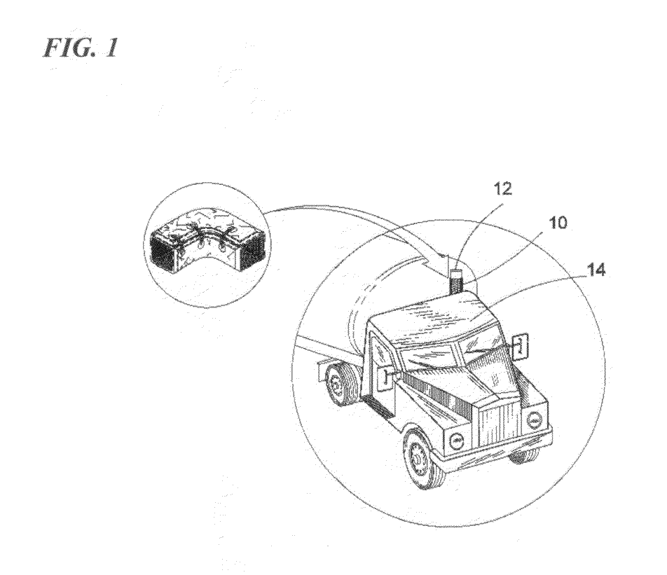

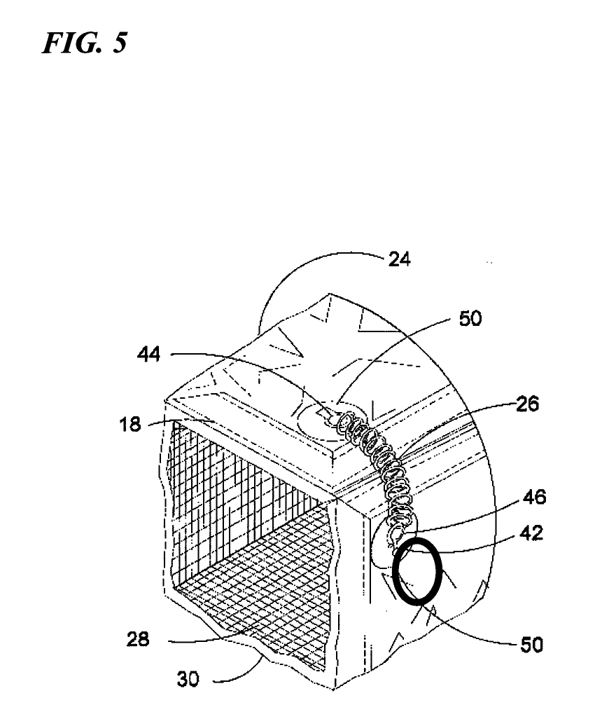

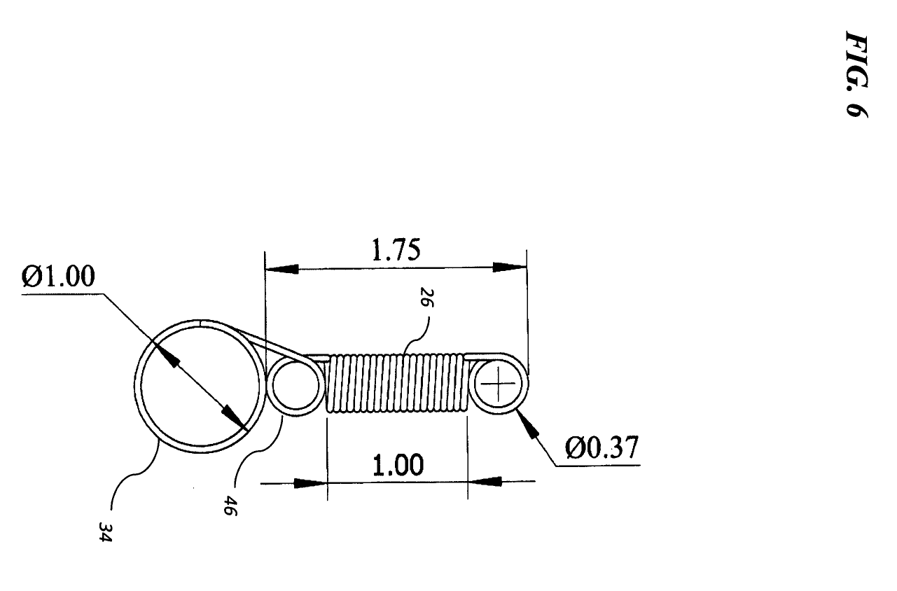

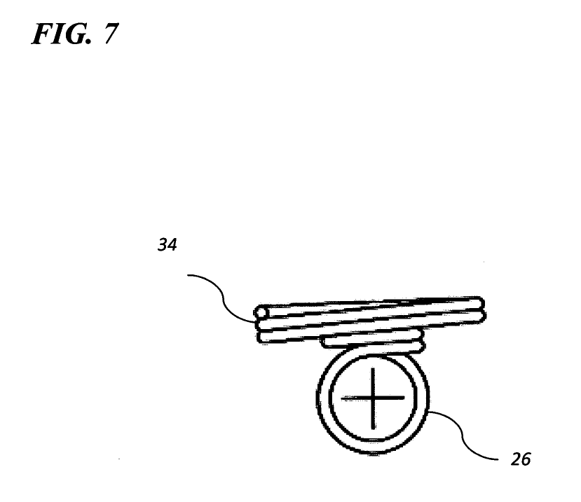

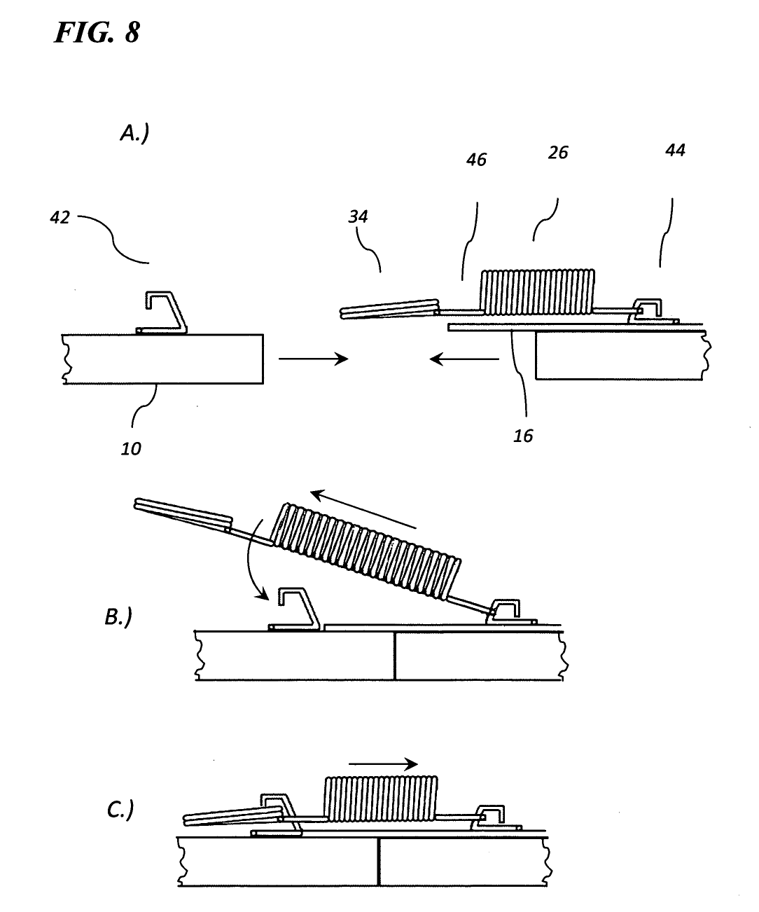

Referring more specifically to the figures, for illustrative purposes the present invention is embodied in the apparatus generally shown in FIG. 1 through FIG. 8.

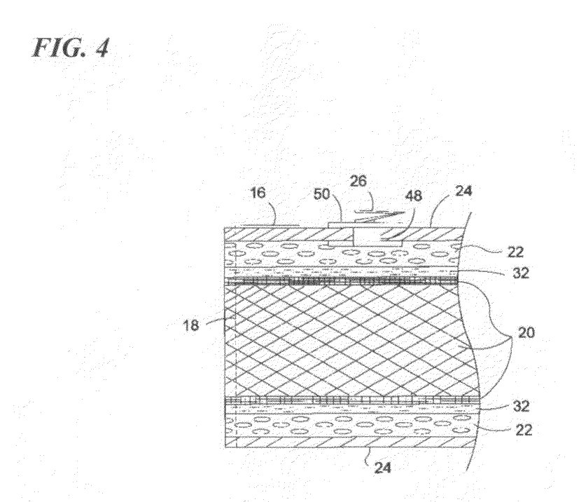

As shown in side cross section FIG. 4, a representative insulative barrier blanket 10 is comprised of an outer protective shell 24, a thermal insulation core 22, and an interior protective layer herein depicted as the combined structure of liner 32 and mesh 20. For the purposes of this application, “inner” and “interior” shall refer to elements or orientation of the insulative barrier blanket 10, which are proximal to a high temperature source and “outer,” and “exterior” shall refer to elements or orientation of the insulative barrier blanket 10 which are distal to a high temperature source.

Insulative barrier blanket 10 is constructed of suitable materials and is of an appropriate design to resist elevated temperatures for protracted periods. Elevated temperatures by which insulative barrier blanket 10 fabricated in accordance with the present invention has thermal insulation properties includes high temperature sources in excess of 500 degrees Fahrenheit, preferably in excess of 1000 degrees Fahrenheit, and most preferably in excess of 1300 degrees Fahrenheit. At such temperatures, insulative barrier blanket 10 exhibits thermal insulation properties for at least 4000 operational hours, preferably for at least 6000 operational hours, and most preferably for at least 8000 operational hours.

Outer protective shell 24 is intended to protect insulative barrier blanket 10 from environmental effectors wherein said blanket is employed to isolate a high temperature source. Environmental effectors include exposure to chemicals, such as water, oils, lubricants and stabilizers, as well as, mechanical forces such as abrasion, impact, and puncture from associated equipment components of the high temperature source and incidental contact during service or inspection by maintenance personnel. Outer protective shell 24 is comprised of materials resistant to chemical interaction and long-term exposure to elevated temperatures, while also exhibiting flexural drape properties. The inventors have found that in the construction of an insulative barrier blanket 10, outer protective shell 24 formed of organic polyamide fibers or PFTE-laminated fiberglass are particularly advantageous in that such fabrics offer a high degree of abrasions, impact and puncture resistance while remaining flexible and sufficiently compliant to allow for the overall blanket construct to readily conform to compound or complex high temperature sources in confined spaces, such as in a diesel engine bay of a tractor. Suitable organic polyamide fibers include aramid fibers such as those available under the KEVLAR registered trademark to DuPont de Nemours, may be used in part or whole in the manufacture of outer protective shell 24, and may be in a knit, woven, or nonwoven fabric construction. Basis weights for the polyamide component in outer protective shell 24 include those within the range of about 16.0 ounces per square yard (oz/yd̂2) and 36.0 oz/yd̂2, preferably within the range of 19.0 oz/yd̂2 and 33.0 oz/yd̂2, and most preferably within the range of 21.0 oz/yd̂2 and 30.0 oz/yd̂2. In the alternative, suitable PTFE-laminated fiber glass may be used in part or whole in the manufacture of outer protective shell 24, and may be in a knit, woven, or nonwoven fabric construction. Basis weights for the PTFE-laminated fiber glass in outer protective shell 24 include those within the range of about 7.0 pounds per cubic foot (lbs/ft̂3) and 12.0 lbs/ft̂3, preferably within the range of 7.5 lbs/ft̂3 and 11.0 lbs/ft̂3, and most preferably within the range of 8.0 lbs/ft̂3 and 11.0 lbs/ft̂3. Outer protective shell 24 may optionally include supplemental layers of fabrics, films, or coatings to further improve barrier performance to chemical exposure, acoustic transfer, physical forces, and/or absorption of fluids. Exemplary supplemental layers include application of silica fabrics and perfluoroplastic based materials.

Thermal insulation core 22 is adjacent to outer protective shell 24 and is the layer next closest to a circumscribed elevated temperature source. The thermal insulation core 22 is constructed of a material suitable for breaking thermal and acoustic conduction pathways from an elevated temperature source and the exterior environment. Thermal conduction pathways which are interrupted include physical contact with the elevated temperature source as well as high temperature gas (typically air) entrained between the elevated temperature source and insulative barrier blanket 10. Useful thermal insulation core 22 compositions include those comprised of inorganic compounds, particularly silicon based materials. Insulative batting may be employed in base weight range of about 7.0 pounds per cubic foot (lbs/ft̂3) and 12.0 lbs/ft̂3, preferably within the range of 7.5 lbs/ft̂3 and 11.0 lbs/ft̂3, and most preferably within the range of 8.0 lbs/ft̂3 and 11.0 lbs/ft̂3. In a preferred embodiment, the insulative batting of choice includes inorganic fibrous materials of various homogenous and blended morphologies. While suitable inorganic fibrous materials may include glass fiber batting (including unmodified and modified fibers such as PTFE laminated and vermiculite laminated), a particularly preferred insulative batting comprises a blend of manmade vitreous fibers together with discontinuous fibrous glass, mineral wool and refractory ceramic fibers (RCFs). Such a blend of fibers as described is commercially available from Unifrax Corp of Pittsburg, Pa. under the trade name of “INSULFRAX 1800”.

The inventors have also found that alternate inorganic compounds in various alternate forms than a fibrous form may be advantageously utilized as a component in the thermal insulation core 22, particularly when a weight reduction in the overall laminate structure is desired. Specifically, an isolation fill layer (not shown) includes a low density, solid-state material (commonly referred to as an “aerogel”). The low density, solid-state material may be in any number of suitable forms, including; bead, particle, fragment, or predefined simple or compound geometric shape, shapes or combinations thereof. A secondary thermal liner may be positioned between the isolation fill layer and the interior protective layer. The secondary thermal liner is comprised of one or more organic or inorganic components and preferentially acts to form a uniform and modulated heat signature to the isolation fill layer.

The aspect of the insulative barrier blankets closest to, and often in direct physical contact with, the elevated temperature source is an interior protective layer. As shown in FIG. 4, the inner protective layer is depicted as the combined structure of high temperature resistant liner 32 and high temperature resistant liner mesh 20. High temperature resistant liner mesh 20 is directly against the elevated temperature source and acts to create a trapped air space and to reduce the total physical contact surface area, which in combinations contributes to the overall insulation performance of insulative barrier blanket 10. High temperature resistant liner mesh 20 is fabricated from a material of suitable composition to resist degradation at temperatures in the range of 1800 degrees Fahrenheit. Nickel alloys have proven to be effective in the construction of mesh 20, with chromium-nickel alloys (“INCONEL” family) and copper-nickel alloys (“MONEL” family) being advantageously employed. A preferred embodiment of the present invention utilizes a mesh 20 formed of a 0.011 inch diameter 240N MONEL wire. High temperature resistant liner 32 is in physical contact with high temperature resistant mesh 20, and thus must have similar resistance to degradation at temperatures in the range of 1800 degrees Fahrenheit. Similarly to mesh 20, nickel alloys have proven to be effective in the construction of liner 32, with chromium-nickel alloys (“INCONEL” family) and copper-nickel alloys (“MONEL” family) being advantageously employed. A preferred embodiment of the present invention utilizes a liner 32 formed of a 2.0 mil MONEL foil.

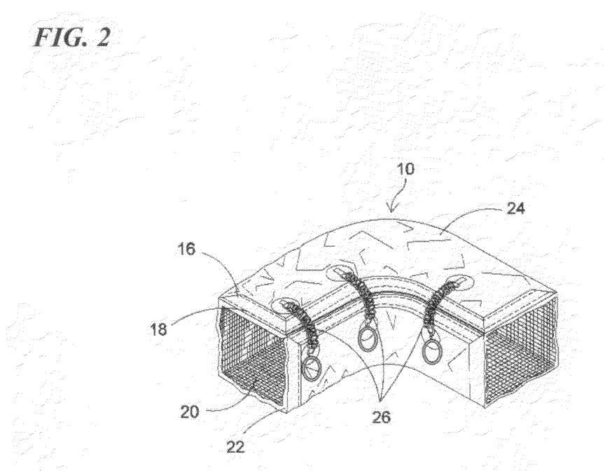

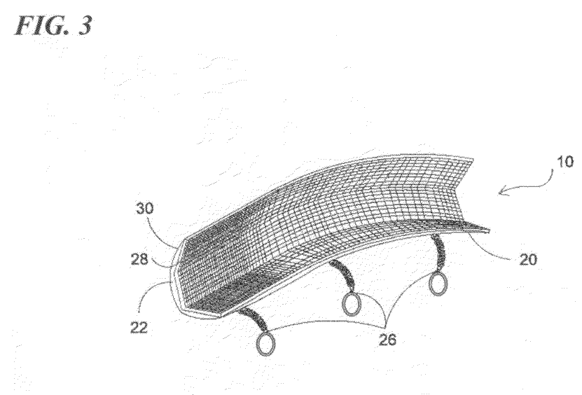

Insulative barrier blanket 10 may be initially formed into an essentially continuous form during manufacturing and subsequently divided into units of smaller total surface area, or in the alternative, may be fabricated from a combination of individual components preformed into the final surface area geometry. Individual insulative barrier blanket 10 is shown in representative form in FIGS. 2 and 3. The layers or elements of the insulative barrier blanket 10 are combined into a laminate structure through binding by an essentially continuous high temperature resistant filament. The binding may be formed through a plurality of sewn stitches 18 traversing the thickness of the insulative barrier blanket 10 using a filament formed from a chromium-nickel alloy (“INCONEL” family) or copper-nickel alloy (“MONEL” family). When sewn stitches of nickel alloy filament are used, the edges of the defined unit as well as plural paths contained with the perimeter of the insulative barrier blanket 10 may be followed for creating sufficient bonding of the layers into a laminate form. A non-limiting preferred embodiment of the present invention utilizes a sewn stitch 18 wherein a double needle sewing machine is utilized to further reinforce the lamination of the constituent layers into insulative barrier blanket 10.

The insulative barrier blanket 10 of the present invention may further include means for disrupting induced heat conductive pathways in the application of the blanket to an elevated temperature source. An example of an induced heat conductive pathway includes voids created through the insulative bather blanket 10 where the edges of the blanket meet or overlap when circumscribed about an elevated temperature source. To prevent thermal conduction through an induced heat pathway, a high temperature resistant seam seal or flap 16 may be integrated to the insulative barrier blanket 10 such that the seam seal 16 extends across the induced pathway. The seam seal 16 may be comprised of one or more heat resistant materials and be suitably pliable so as to conform to the edge profile of the region where the insulative barrier blanket 10 meets or overlaps. A preferred embodiment of an overlying seam seal 16 includes a laminate construction utilizing a mesh of 0.011 inch diameter 240 N MONEL wire mesh, a secondary mesh of 0.008 inch diameter 304 stainless steel wire at a density of about 60.0 lbs and an inorganic fiber fabric at density of about 18 ox/yd̂2.

In order to retain an insulative barrier blanket 10 to an elevated temperature source, it is necessary to incorporate into the laminate structure means for releasably affixing the blanket about the elevated temperature source. A number of suitable means exist for attaching, removal, and reattaching an insulative barrier blanket 10 to an elevated temperature source, including but not limited to: threading a retentive wire through eyelets; hook and loop; and, spring closures as presented in the aforementioned and incorporated U.S. Pat. No. 6,444,287 reference. The inventors have found that a useful improvement in the use of a spring closure is the inclusion of an integral secondary grasp loop 34 (as shown in FIGS. 2, 3, 6 through 8). The secondary grasp loop 34 allows for the improved application of leverage by hand to draw the spring closure 26 across the edges of the insulative barrier blanket 10 and to engage into a corresponding “L-shaped” hook 42 incorporated in the laminate structure and opposite to the origination and mounting point of spring closure 26. The utility of secondary grasp loop 34 is not constrained to a specific geometry (for representative purposes being shown as essentially circular) and may include simple or compound straight, angled, curved shapes and the combinations thereof such as is conducive to manipulation by hand or other such leverage device. Further, secondary grasp loop 34 is preferably integral to the formation of the spring closure 26, itself. The advantages in an integrated and essentially continuous secondary grasp loop 34 includes, but is not limited to; resistance to structural failure, reduction in wear, reduced vibration induced noise, improved resistance to acoustic transfer and prevention of potential loss of a separately engaged element and resulting foreign object debris concerns thereof. The secondary grasp loop 34/spring closure 24 element may be formed from a composition exhibiting appropriate memory retention and elastic behaviors, such as a stainless steel formed wire.

A representative application of an insulative barrier blanket 10 is depicted in FIG. 1. An insulative barrier blanket 10 circumscribes an elevated temperature source in the form of an exhaust stack 12 depending from an internal combustion engine in vehicle 14. Such application of an insulative barrier blanket 10 is beneficial in the combined effects of reducing ambient environmental temperatures within the vehicle and the respective engine bay while simultaneously maintaining the exhaust temperature at a point optimal for effective operation of the internal combustion engine. For example, associated catalytic emission control and turbo charging devices used in modern internal combustion engines are adversely affected by significant deviation from an optimized operational temperature, but which is effectively controlled through use of the present invention.

### Example

An acoustic bather material made in accordance with the present invention was tested for acoustic performance in accordance with SAE J1400 (May 90), “LABORATORY MEASUREMENT OF THE AIRBORNE SOUND BARRIER PERFORMANCE OF AUTOMOTIVE MATERIALS AND ASSEMBLIES”. The sample size was approximately 36 inch by 36 inch. The transmission loss window opening was 24 inch by 24 inch. The SAE standard specifies that the lowest measurement frequency is 100 Hz for a window of this size and tested through the range up to and including the highest frequency of 5000 Hz. Measurements were conducted in a full size (240 m³) reverb room (source room) with a small anechoic reception chamber. The wall construction between the two rooms was 8 inch concrete block with a 1 inch air gap and a second 8 inch concrete block wall. The concrete block walls were filled with foam. The reverb room is qualified to make absorption measurements as per ASTM C423.

Five microphones in the reverberation room monitored the source noise levels. A single low noise microphone was used in the reception chamber. The microphone was attached to a stepper motor. The stepper motor moved the microphone to 5 positions and stopped at each of these 5 positions while a measurement was made. Each measurement was 30 seconds.

The noise in the reverberation room was generated by 4 loudspeakers, one in each of the corners of the room. The signal fed to the speakers was while noise generated by the Bruel and Kjaer PULSE system. That white noise signal was shaped so that there was much more high frequency energy then low frequency energy. This was done to optimize the dynamic range in the reception chamber. Without noise shaping the spectrum will typically be dominated by low frequency energy and the high frequency energy will be nearly in the noise floor of the measurement system. Levels in the 4 and 5 kHz ⅓-octave bands in the source room were over 100 dB.

A special low noise microphone used in the reception chamber is capable of measuring noise levels below 0 dB. The measured levels in the reception chamber were always at least 15 dB above the background noise levels in the measurement system. The reception room microphone was approximately 6 inch (150 mm) from the surface of the sample.

The SAE J1400 procedure requires the measurement of a reference sample. A sheet of EVA was used as the reference. The surface density of the EVA sheet was 1.9 lb/ft² (9.4 kg/m²). All samples were tested with a steel panel on the source room side. The steel panel was 0.073 inch (1.86 mm) thick and had a surface density of 2.98 psf (14.57 ksm).

The relative humidity ranged from 50% to 60% during testing. The temperature was 70° F. (21° C.). Results of the testing are provided in Table 1.

TABLE 1

| | Transmission Loss (dB) | | |
|---|---|---|---|
| | High | Medium | |
| | Temperature | Temperature | |
| | Resistance | Resistance | |
| Frequency | Barrier | Barrier | EVA Control |
| 100 | 12.1 | 12.0 | 16.5 |
| 125 | 15.9 | 14.9 | 17.5 |
| 160 | 19.8 | 19.0 | 20.3 |
| 200 | 24.5 | 23.9 | 23.3 |
| 250 | 30.3 | 30.9 | 23.7 |
| 315 | 37.0 | 35.4 | 27.5 |
| 400 | 42.7 | 39.9 | 29.4 |
| 500 | 47.2 | 43.7 | 32.3 |
| 630 | 49.6 | 46.5 | 33.6 |
| 800 | 50.3 | 50.4 | 34.9 |
| 1000 | 53.6 | 54.8 | 36.3 |
| 1250 | 59.1 | 57.7 | 37.9 |
| 1600 | 65.7 | 62.0 | 39.4 |
| 2000 | 70.1 | 63.8 | 41.4 |
| 2500 | 75.0 | 65.5 | 42.7 |
| 3150 | 80.0 | 68.9 | 44 |
| 4000 | 85.3 | 78.4 | 44.9 |
| 5000 | 90.7 | 83.6 | 43.1 |

Although the description above contains many details, these should not be construed as limiting the scope of the invention but as merely providing illustrations of some of the presently preferred embodiments of this invention. Therefore, it will be appreciated that the scope of the present invention fully encompasses other embodiments, which may become obvious to those skilled in the art. In the appended claims, reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the disclosure and present claims. Moreover, it is not necessary for a device or method to address every problem sought to be solved by the present invention, for it to be encompassed by the disclosure and present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An insulative barrier blanket comprising;
a. a high temperature abrasive and puncture resistant outer protective shell,
b. a thermal insulation core,
c. an interior protective layer,
wherein said outer protective shell is preferentially made of a layer comprising organic polyamide fiber,
wherein said interior protective layer is comprised of a high temperature resistant liner layer and a high temperature resistant liner mesh layer.

2. An insulative barrier blanket as in claim 1, wherein said organic polyamide fiber is an aramid fiber.

3. An insulative barrier blanket as in claim 1, wherein said high temperature resistant liner layer comprises a nickel alloy.

4. An insulative barrier blanket as in claim 1, wherein said outer protective shell, said thermal insulation core, and said interior protective layer are bonded together by a mechanical means.

5. An insulative barrier blanket as in claim 4, wherein mechanical means is a sewn stitch using an essentially continuous filament.

6. An insulative barrier blanket as in claim 5, wherein said essentially continuous filament comprises a nickel alloy.

7. An insulative barrier blanket as in claim 1, wherein said insulative barrier blanket has insulation properties to a heat source in excess of 500 degrees Fahrenheit.

8. An insulative barrier blanket as in claim 1, wherein said insulative barrier blanket has insulation properties for at least 4000 operational hours.

9. An insulative barrier blanket comprising;
a. a thermal insulation core,
b. an outer protective shell,
wherein said insulative barrier blanket exhibits a 35% improvement in transmission loss at 500 Hz and a 90% improvement in transmission loss at 5000 Hz when tested in accordance with SAE J1400 (May 90).

10. An insulative barrier blanket as in claim 9, wherein said thermal insulation core further comprises a secondary thermal liner.

11. An insulative barrier blanket as in claim 9, wherein said thermal insulation core is comprised of a low density, solid-state inorganic compound.

12. An insulative barrier blanket as in claim 9, wherein said high temperature resistant liner layer comprises a nickel alloy.

13. An insulative barrier blanket as in claim 9, wherein said outer protective shell, said thermal insulation core, and said interior protective layer are bonded together by a mechanical means.

14. An insulative barrier blanket as in claim 13, wherein mechanical means is a sewn stitch using an essentially continuous filament.

15. An insulative barrier blanket as in claim 14, wherein said essentially continuous filament comprises a nickel alloy.

16. An insulative barrier blanket as in claim 9, wherein said insulative barrier blanket has insulation properties to a heat source in excess of 500 degrees Fahrenheit.

17. An insulative barrier blanket as in claim 9, wherein said insulative barrier blanket has insulation properties for at least 4000 operational hours.

18. A method for releasably affixing an insulative barrier blanket to an elevated temperature source comprising:
a. providing an insulative barrier blanket having at least one spring closure element attached by one end to said insulative barrier blanket and having one end extending away from said attached end, and said insulative barrier blanket having at least one receiving hook fastener affixed thereto,
b. circumscribing an elevated temperature source with said insulative barrier blanket such that said spring closure comes into proximity of said hook fastener,
c. drawing said extended end of said spring closure element to and engaging upon said receiving hook,
wherein said extend end of said spring closure has integral therein a secondary grasp loop; and
wherein said insulative barrier blanket has two separate and opposing edges.

19. A method as in claim 18, wherein said spring closure element is affixed to a first separate and opposing edge and said hook fastener is affixed to second separate and opposing edge.

20. A method as in claim 18, wherein said insulative barrier blanket further comprises a seam seal element which bridges across said edges.
